(19) United States
(12) Patent Application Publication
(10) Pub. No.: US 2006/0088470 A1
(43) Pub. Date: Apr. 27, 2006

(54) Inorganic beads with hierarchical pore structures

(76) Inventors: Anders Larsson, Uppsala (SE); Ulrika Meyer, Uppsala (SE)

Correspondence Address: AMERSHAM BIOSCIENCES;PATENT DEPARTMENT, 800 CENTENNIAL AVENUE, PISCATAWAY, NJ, 08855, US

(21) Appl. No.: 10/545,487

(22) PCT Filed: Feb. 18, 2004
(86) PCT No.: PCT/EP04/01533

§ 371 Date: Aug. 12, 2005

(30) Foreign Application Priority Data
Feb. 21, 2003 (SE) 0300482.7

(51) Int. Cl. C01B 39/04; C01B 39/00

(52) U.S. Cl. 423/702; 423/709

(57) ABSTRACT

Disclosed is a method for the production of porous inorganic beads with hierarchical pore structures for use, for example, in chromatographic separation procedures. The method comprises combining in a liquid medium at least one porous templating particle and a matrix material precursor under conditions such that the matrix material precursor is allowed to infiltrate the templating particle(s); allowing the matrix material precursor to solidify to form composite beads; and removing the templating particle(s) from the composite bead(s) thereby forming porous beads comprising a porous matrix supplemented with one or more larger pores corresponding to the cavities left by the removed templating particle(s). Preferred are silica, titania and zirconia beads. The invention also provides a separation matrix comprising inorganic beads exhibiting a hierarchical pore structure. The inorganic beads have large surface areas, thereby allowing for high adsorption capacities of target molecules, and improved mass transport properties, particularly at high flow rates.

The present invention relates to a method for the production of porous beads for use, for example, in a chromatographic separation procedure. In particular, the invention relates to a method for creating inorganic beads with hierarchical pore structures that give improved mass transport properties, particularly at high flow rates.

A general problem in chromatography, adsorption processes, heterogeneous catalysis etc, where porous particles are used, is that the mass transport rate is strongly dependent on the particle size. Rapid mass transport can be achieved by decreasing the particle size, but small particles will also increase the backpressure of the packed beds. Hence, a compromise must be made between the mass transport rate and the pressure-flow properties. One way to improve the mass transport in a porous particle is to introduce a hierarchical pore structure, where large feeder pores from the particle surface open into a network of smaller pores with a large surface area available for adsorption.

There are several published reports describing templating procedures for preparing porous inorganic oxide structures, suitably by infiltrating the void spaces of organic or bacterial templates with inorganic precursors. For example, latex particles (non-porous nanosized beads) have been used as templates to form cavities in porous bulk structures (WO 99/21796 (Antonietti, M. et al; U.S. Pat. No. 5,951,962 (Mueller, U. et al); WO 00/26157, (Yang, P. et al); Antonietti, M. et al, Adv. Mater., (1992), 10(2), 710-712; Wang, D, et al, Adv. Mater., (2001), 13, 364-371; Yang, Z., et al, Chinese Science Bulletin, (2001), 45(21), 1785-90); Meyer, U. et al, Adv. Mater., (2002), 14(23), 1768-72). Inorganic frameworks composed of oxides of Si, Ti, Zr, Al, W, Fe, Sb, and a Zr/Y mixture have been prepared from metal alkoxide precursors templated around polystyrene spheres to form highly ordered macroporous materials (Holland, B. T. et al, Chem. Mater., (1999), 11, 795-805).

The fabrication of hierarchically ordered structures has added a new dimension to existing processes for preparing nanostructured materials. Zhang, B. et al (J. Chem. Soc. Chem. Commun., (2000), 781-2) describes the synthesis and characterisation of hierarchically structured zeolite fibres containing ordered pores at the nano- and micro-scopic length scale using an aqueous dispersion of zeolite nanoparticles as building blocks. Fan, H. et al, (J. Non-Cryst. Solids, (2001), 285, 71-78) describe the synthesis of nanoporous silica particles having well defined pore structures and voids through an aerosol-assisted self assembly process templated by surfactant, polystyrene spheres and oil-in water emulsions. In this process, the polystyrene spheres serve as templates for isolated cavities rather than by infiltrating porous beads.

The various methods suggested in the prior art suffer from certain drawbacks and limitations. These include, poor connectivities of the pore structures: whenever superpores are produced by templating with particles dispersed in the porous matrix, the connectivity of the cavity network is dependent on extensive particle-particle contacts that may be difficult to achieve. For example, using zeolites as building blocks means that the small pores of porous structured materials will be of sub-nanometer dimensions, which is too small for their use as chromatography media for biomolecules. There are practical difficulties applying the above techniques for the preparation of hierarchically structured porous beads (in particular monodispersed beads which are suitable for such applications as chromatography, catalysis and solid phase synthesis). Thus, there is still a need for improved methods for the production of hierarchically structured porous inorganic beads.

Accordingly, one object of the present invention is to provide a porous inorganic bead, whereby an essentially hierarchical network of pores is provided in each bead, for use, for example in chromatographic separation procedures, catalysis, solid phase synthesis, etc. It has been surprisingly found that, through the use of large-pore, porous templating particles, porous inorganic beads may be produced wherein the beads exhibit a hierarchical pore structure that favours improved mass transport in process chromatography media. Beads having a hierarchical pore structure may also be obtained using porous templating particles in which the templating process is performed in the presence of a surfactant. The resultant beads have large surface areas, thereby allowing for high adsorption capacities of target molecules. This is achieved by the methods of producing porous inorganic beads as defined in the appended claims.

In a first aspect of the present invention, there is provided a method of producing at least one porous bead, which comprises the steps of:

i) combining in a liquid medium at least one porous templating particle and a matrix material precursor under conditions such that said matrix material precursor is allowed to infiltrate said templating particle(s);

ii) allowing said matrix material precursor to solidify to form composite beads; and

iii) removing said templating particle(s) from said composite bead(s) thereby forming porous beads comprising a porous matrix supplemented with one or more larger pores corresponding to the cavities left by the removed templating particle(s);

characterised in that said at least one porous templating particle is a bead having a macroporous structure and/or said combining step i) is performed in the presence of a surfactant;

whereby an essentially hierarchical network of pores is provided in each bead.

In one preferred embodiment of the method, the porous templating particle is a bead having a macroporous structure and the combining step i) is performed in the absence of a surfactant. In a second preferred embodiment, the porous templating particle is a bead having a macroporous structure and said combining step i) is performed in the presence of a surfactant.

In the context of the present invention, the term “templating” means the solidification of a fluid in the presence of solid features and where, upon removal of said solid features a corresponding cavity is formed. The term “hierarchical” is used to describe a porous structure with large pores open to the exterior. On the walls of these large pores, a system of smaller pores opens. Optionally, a further system of even smaller pores may open on the walls of these pores etc. A hierarchical pore structure may also have a fractal character, in which case the larger pores continuously divide into smaller pores. The term “multimodal” when referring to pore structure, means a structure having several distinct classes of pore sizes. Typically, pores may be “bimodal” or “trimodal”, having respectively two or three distinct classes of pore size. These may or may not be connected in a hierarchical structure. By the term “intraparticle pore volume”, it is meant the volume of pores inside the beads, as opposed to the interstitial pores in a packed bed of beads. According to the IUPAC definition, “micropores” are of a diameter <2 nm, “mesopores” have a diameter within the interval of 2-50 nm and “macropores” are of a diameter >50 nm.

Accordingly, the method of the present invention provides porous inorganic beads having a multimodal hierarchical pore structure. Typically, the method produces beads having a bimodal or sometimes trimodal, preferably bimodal hierarchical pore structure, with smaller pores, usually the size of the type conventionally denoted as mesopores, being connected to macroporous cavities or channels that are formed when the templating particle is removed. The said cavities or channels are sometimes for reasons of simplicity referred to herein as “superpores”, and are usually of diameter in the range of between about 50 nm and about 20,000 nm. The conventional mesopores are for the same reason sometimes denoted “small pores”, even though the term “small pores” as used herein may also include micropores. Accordingly, the small pores are of smaller diameter than superpores and may have a diameter in the range of between about 1 nm and about 100 nm.

The overall shape of the porous inorganic beads according to the present invention will depend generally on the shape of the templating particle from which the beads are derived. Preferably, beads prepared by the method of the invention are spherical or substantially spherical in shape, having a diameter in the range from about 1 μm to about 500 μm. In preferred embodiments, the bead size is in the range from about 10 μm to about 100 μm, and in particularly preferred embodiments from about 30 μm to 60 μm.

Matrix material precursors suitable for use in the method according to the present invention are suitably metal salts or complexes, or metallo-organic compounds, which are capable of being converted into gels, and wherein the gels can be converted to the corresponding metal oxide, or alternatively converted to the corresponding nitride, boride or carbide. Preferably, the matrix material precursor is a metal salt or a metal or metalloid complex. Preferably, the precursor is soluble in a suitable reaction medium. Suitable metal salts include C₁-C₄ metal alkoxides, carbonates and carboxylates of metals and metalloids such as silicon, titanium, zirconium, tungsten, calcium, aluminum and boron. Suitable complexes include acetoacetonates, carbonyls and cyclopentadienyls of metals and metalloids, such as silicon, titanium, zirconium, tungsten, cerium, hafnium, iron, aluminium, calcium and boron. Alternatively, the precursor may be present as a suspension, for example, in the form of a colloidal sol of silica, titania or zirconia.

In one preferred embodiment, the matrix material precursor is tetra-C₁-C₄ alkyl orthosilicate which, upon calcination, forms SiO₂ (silica) porous beads. Suitable tetraalkyl orthosilicates include tetramethyl orthosilicate and tetraethyl orthosilicate. In another preferred embodiment, the matrix material precursor is titanium(IV) isopropoxide which, upon calcination, forms TiO₂ (titania) porous beads. In a still further preferred embodiment, the matrix material precursor is a zirconium(IV) propoxide which, upon calcination, forms ZrO₂ (zirconia) porous beads.

The porous inorganic beads according to the present invention may be produced according to the “sol-gel” method, wherein macroporous (large-pore) template particles are infiltrated with a sol-gel matrix material precursor solution, suitably an aqueous or aqueous/C₁-C₄ alcohol solution. The matrix material precursor undergoes hydrolysis and condensation to form the corresponding metal oxide within the pore structure of the templating particle. It is important to keep the amount of precursor to a minimum in order to prevent the formation of excess inorganic material on the surface of the beads and reduce the effect of “clumping”. Thus, the precursor solution only fills the templating particles such that, following gelation, a free-flowing powder of composite beads is formed. The composite beads are then calcined in order to remove template particle skeletons, thereby resulting in the formation of meso-macroporous beads having a hierarchical pore structure. Without being bound by theory, the meso pores in the resultant bead structure are likely to be formed from interstitial pores formed during the gelation of the sol-gel matrix material precursor. Some shrinkage occurs in the inorganic bead after the calcination step, particularly in the case of titania and zirconia bead types.

Suitably, for preparing beads having a hierarchical structure, the porous templating particle is a bead having a macroporous (i.e. large pore) structure with at least 50% of the pore volume in pores with diameters in the range from about 40 nm to 20,000 nm, preferably from about 100 nm to 10,000 nm. In one embodiment, the porous beads are organic beads, suitably styrene-divinylbenzene beads such as SOURCE 30 RPC, SOURCE 30 Q, SOURCE 30 S, SOURCE 15 ETH, SOURCE 15 RPC, SOURCE 15 S, SOURCE 15 Q (all functionalised polydivinylbenzene beads from Amersham Biosciences), F-BAS/18, F-BAS/26 (both large-pore polydivinylbenzene bead prototypes from Dyno Speciality Polymers), large-pore glycidyl methacrylate/glycerol dimethacrylate (GMA/GDMA), styrene/ethylene glycol dimethacrylate beads, foamball beads (e.g. prepared according to U.S. Pat. No. 5,902,834, Porrvik, I.). Other suitable templating particles are large-pore beads prepared from phenol-formaldehyde resins, melamine-formaldehyde resins, polyolefins, cellulose esters, vinyl polymers, polyurethanes, carbon beads, etc. Such templating beads are stable over the range from pH 2 to 12, thereby making possible the use of acidic or basic conditions during the templating process.

In another embodiment, an inorganic templating particle may be used, suitably silica, diatomite, glass, alumina or silicate mineral particles that can afterwards be dissolved by leaching with e.g. alkali or hydrofluoric acid.

In a preferred embodiment, the templating particles are selected from porous organic polymer beads having at least 50% of their total intraparticle pore volume in pores in the range from 100 nm to 10,000 nm pore diameter, preferably from 200 nm to 10,000 nm, most preferably from 250 nm to 10,000 nm.

The surface chemistry of the templating particle is an important factor in the outcome of the method of the present invention. Thus, the surface properties of the templating particle, in terms of surface hydrophilicity or hydrophobicity, should be controlled in an appropriate way, such that the templating particles are preferably wetted by the matrix material precursor solution, thereby enhancing infiltration of the templating particle by the matrix material precursor. Accordingly, in an advantageous embodiment, the present method further comprises the step of treating the templating particles with a surface-modifying agent. Such treatment of the templating particles may be before, or during, the addition thereof to the templating mixture. Treatment before step i) is to be particularly preferred. The terms “treated” and “treatment” are understood to mean herein that the surface modifying agent will react with or adsorb to the particle surface to a sufficient extent to provide the desirable surface characteristics.

For preparing silica beads according to the present invention, the preferred surface characteristics of the template particles are hydrophillic in nature. The template particle surface may be modified by means of an agent in order to enhance the hydrophillicity of the surface. In functional terms, the said agent may be any molecule with one or more hydrophillic regions or groups, such a molecule being capable of reacting with, or physically adsorbing to the particle surface such that the hydrophillic regions or groups point outwards from the surface. Suitably, surface modification includes chemical means, such as by derivatisation of the template particle with sulphonate (—SO₃⁻), or amino (—NH₂) groups, or by sorbitol functionalisation. Alternatively, surface treatment of the templating particle may be performed by adsorbing surface modifying moieties such as poly(diallyldimethylammonium chloride) and phenyldextran. Preferred beads for templating silica beads are selected from hydrophillic beads, e.g. sulfonated or aminated styrene-divinylbenzene beads, and amine-derivatised GMA/GDMA beads.

Alternatively, for preparing titania beads and zirconia beads according to the invention, the surface characteristics of the templating particles are preferably hydrophobic in nature. Preferred beads are selected from F-BAS/18, F-BAS/26, EGDMA/styrene and styrene foamballs. The surface of the templating particle may be modified to further enhance hydrophobicity of the surface by treatment with a hydrophobic agent such as a fatty acid, a fatty amine, a hydrophobic silane, etc. In functional terms, said agent can be any molecule with one or more hydrophobic regions or groups that is capable of reacting with or physically adsorbing onto the surface of the templating particle is such a manner that the hydrophobic regions or groups point outwards from the surface. Accordingly, a suitable agent is readily selected by the skilled person, since a large number of such surface modifying agents are commercially available.

Methods for modification of surfaces are well known to the skilled person and various handbooks and literature describe the general principles and considerations needed. See, for example, “Ion Exchangers”, K. Dorfner (Ed.), Berlin (1991).

When porous beads are used as templates according to the present invention, the characteristics of their pore surfaces are of importance for the outcome of the process. In the case where the beads are impregnated with an aqueous solution containing e.g. a silica precursor, it is essential that the beads are well wetted by the solution (i.e. that they are sufficiently hydrophilic, which can be assessed by a water absorption test) and it is also advantageous if the pore surfaces have a high affinity to the inorganic material formed (e.g. by having a basic character in the case of silica which is an acidic oxide). In the case where the dry beads are impregnated with moisture-sensitive precursors such as titanium or zirconium alkoxides, the best results are obtained if the pore surfaces are hydrophobic.

The liquid medium used for performing the reaction may be any medium compatible with handling, and subsequently hydrolysing, the matrix material precursor to form composite beads. For example, with silica precursors, water may be employed as the reaction medium. Alternatively, the liquid medium may be a mixture of water with a water-miscible organic solubilizer, such as a C₁-C₄ alcohol, for example methanol, ethanol or isopropanol, 1,4-dioxane, tetrahydrofuran, or acetonitrile. The reaction can also be performed in a two-phase liquid reaction medium, which consists of an aqueous phase and an organic phase which is immiscible or only slightly miscible with water. In relation to the reaction according to the present invention, the organic phase should be inert. A suitable organic phase includes hydrocarbons (e.g. toluene), ethers (e.g. diethyl ether), ketones (e.g. methylethyl ketone), esters, higher alcohols, etc. Care should be taken when handling certain matrix material precursors, for example, precursors of titania and zirconia, which must be infiltrated under completely water-free conditions. Subsequent hydrolysis of the precursor is carried by the controlled addition of water or moisture to a non-aqueous solution of the precursor. The reaction medium or the two-phase mixture is suitably agitated, in particular stirred, during the reaction.

The formation of a hierarchical pore structure may be enhanced by the addition of one or more surfactants or other sacrificial pore forming agents to the templating reaction mixture. Thus, in one embodiment according to the present invention, the combining step i) is performed in the presence of a surfactant. The surfactant may be present in the liquid medium when the porous templating particle(s) are added therein. Alternatively, the templating particle(s) may be treated with a surfactant before they are added to the liquid medium. Suitable surfactants include quaternary ammonium salts (e.g. cetyltrimethylammonium bromide, CTAB), sulphosuccinates (e.g. sodium dioctyl sulphosuccinate), ethoxylated alcohols (e.g. ethoxylated fatty alcohols or alkyl phenols), polyethers (e.g. ethylene oxide-propylene oxide block copolymers), alkyl sulphates (e.g. sodium dodecyl sulphate), sulphonates (e.g. sodium dodecylbenzene sulphonate), etc. The addition of a surfactant to the templating reaction mixture is particularly advantageous if template particles having pore diameters less that about 100 nm are employed. For example, hierarchical porous silica beads may be produced using SOURCE15ETH templating beads (with pores <100 nm) and the surfactant CTAB.

After the liquid matrix material precursor has been allowed to infiltrate the pores of the template, the precursor is converted to a gel by aqueous hydrolysis of the matrix material precursor. Optionally, the hydrolysis may be performed under acidic or basic conditions, wherein the presence of an acid or a base may facilitate the conversion. Preferably, the matrix material precursor is converted into a gel by treatment of the precursor with water and (in the case of silicon alkoxides), more preferably by treatment with one or more dilute aqueous acids or bases. When an acidic or a basic medium is used, the acid or base is present at a concentration range of about 1 mmol/l to 0.5 mol/l, most preferably about 10 mmol/l. Preferred acids include acetic acid, hydrochloric acid, sulphuric acid, nitric acid etc. Preferred bases include ammonia, amines, alkali hydroxides etc. Most preferably, when the matrix material precursor is a titanium or a zirconium alkoxide, conversion to a gel is effected by water treatment, whereas with silicon alkoxide precursors addition of approximately 10 mmol/l hydrochloric acid is to be preferred.

The gel conversion reaction to form a composite bead is suitably performed at a temperature of between 20° C. and 100° C. Generally, higher temperatures within this range will facilitate infiltration of the liquid ceramic precursor and conversion to a gel, a preferred temperature range being between 50° C. and 80° C. The reaction is suitably allowed to proceed from about 1 hour to about 5 days, preferably from 12 hours to 72 hours. The time and temperature needed to convert the ceramic precursor to a gel will vary due to the reactivity of the precursor used and due to the presence of any accelerating (e.g. acids and bases) or retarding compounds.

The composite beads in which gel is disposed throughout at least a portion of the templating particle, may be converted to the porous inorganic beads according to the present invention, by heating the templated gel, suitably at a temperature of between about 300° C. and 1000° C. for a period of time sufficient to convert the gel to a ceramic material and concomitant removal of the template. A preferred temperature suitable for calcining the beads will be in the range from 550° C. to about 750° C., depending on the inorganic composition of the gel. It is generally preferred to calcine the beads by means of a two-stage heating program, wherein, in a first stage the temperature is raised from ambient to the final calcining temperature in a gradient over a period of 1.5-2.5 hours. In a second stage, the beads are calcined at the preferred temperature for a period of between 1 hour to 24 hours. It is preferred to pass a constant air flow through the calcination furnace, so as to ensure the complete combustion and removal of the organic template material.

In the embodiment wherein an inorganic templating particle is employed, the template must be removed from the composite beads by methods that do not affect the matrix material. For example, a porous silica templating particle may be used to template titania or zirconia beads. Titania or zirconia matrix material precursor is allowed to infiltrate the pores of the silica template and form metal oxide as described. The templating particles may be removed from the composite beads by the use of conventional leaching methods depending on the nature of the bead matrix and the templating particle. Naturally, the leaching agent should be selected so as not to have a negative impact on the properties of the bead, while being sufficiently aggressive for efficient removal. In one embodiment, removal of the templating particle may be performed by etching the silica template by the addition of fluorine compounds, for example, hydrofluoric acid or ammonium bifluoride. In another embodiment, the etching is performed by the addition of one or more bases, for example sodium or potassium hydroxide, which are suitable in the case of alkali soluble templating particles.

As mentioned above, in an advantageous embodiment according to the present method, the templating particles are surface treated before combining the particles with matrix material precursor. Such pre-treated particles may be prepared as a step preceding step i). Alternatively, pre-treated particles for use as templates may be obtained from commercial sources. For example, large-pore styrene-divinylbenzene beads with anion exchange functionality (and hence basic and hydrophilic pore surfaces) are available from Purolite International as a product designated A501P.

In a typical example of the preparation of silica beads, organic template beads, suitably sulfonated or aminated F/BAS-18 or FIBAS-26, or amine derivatised GMA/GDMA beads, are dried in an oven at 60° C. overnight. Dried beads are soaked in 0.01M HCl solution in a reactor equipped with stirring means. By this procedure, fewer aggregates of beads are formed. Optionally, a surfactant may be included in the reaction mixture, preferably prior to addition of the beads. Tetramethylorthosilicate is added to the reactor and the reaction allowed to proceed at 70° C. during 72 hours. Either acidic or basic sol-gel hydrolysis may be employed, acidic conditions being more generally applicable. The beads are washed on a glass filter with deionized water and the washed beads dried at 60° C. overnight. The dried beads are calcined, complete combustion of organic material being ensured by allowing a constant airflow through the oven.

For preparing titania and zirconia beads, templating particles having a hydrophobic surface character are to be preferred. Suitable examples that may be used include styrene/DVB templates, F/BAS-18, F/BAS-26, EGDMA/styrene and foamballs. The dried templating particles are soaked in a limited amount of bulk titania (or zirconia) precursor and thereafter, the reaction is initiated by adding distilled water.

In a second aspect of the present invention, there is provided a separation matrix comprising porous beads produced according to the method described above, characterised in that an essentially hierarchical network of pores is provided in each bead.

Preferably, the beads are spherical or substantially spherical in shape, having a diameter in the range from about 1 μm to about 500 μm, preferably in the range from about 10 μm to about 100 μm.

The porous inorganic beads according to the invention may be used as separation matrices in process chromatography methods. The inorganic beads have large surface areas, thereby allowing for high adsorption capacities of target molecules, and improved mass transport properties. Thus, in a third embodiment, there is provided a liquid chromatography procedure for separating and distinguishing at least one solute in a chromatography column containing a stationary separation matrix, including the steps of flowing through said column a discrete volume of a liquid mixture containing said solute(s) and eluting from said separation matrix said solute(s) bound thereto; characterised in that said separation matrix is comprised of porous beads exhibiting an essentially hierarchical pore structure that favours mass transport, wherein the beads are obtainable according to the method of the invention.

One specific advantage of the method for producing beads according to the present invention is that it is possible to prepare mono-dispersed beads, providing that mono-dispersed polymer beads are used as template. The present technique will also produce different types of pore structures, thereby widening the scope of possible structures. The presence of a physically connected structure in the porous bead template means that the superpores in the resulting hierarchically structured bead will be connected throughout the bead. It is also possible to manipulate the porosity and the mechanical properties by varying the amount of precursor used and the amounts of surfactants or other sacrificial pore forming agents.

In many chromatography applications the pore surfaces of the beads may be chemically modified to give the desired adsorption selectivity. The modification can involve the fixation of ligands (interacting groups) including charged groups for ion exchange chromatography (for example, —N⁺(CH₃)₃), —SO₃⁻, —COO⁻); hydrophobic groups (hydrophobic interaction chromatography); or groups with affinity to specific proteins etc (affinity chromatography). Alternatively, applications may also involve complete coating of the pore surfaces with a hydrophobic layer (reversed phase chromatography) or a protein-inert hydrophilic layer (gel filtration chromatography). In some cases it may be necessary to combine coating and ligand immobilisation processes, for example, by first applying an inert hydrophilic coating and then attaching the ligands to the coating.

The invention is further illustrated by reference to the following examples and figures which are presented herein for illustrative purposes only and should not be construed as limiting the scope of the present invention as defined by the appended claims.

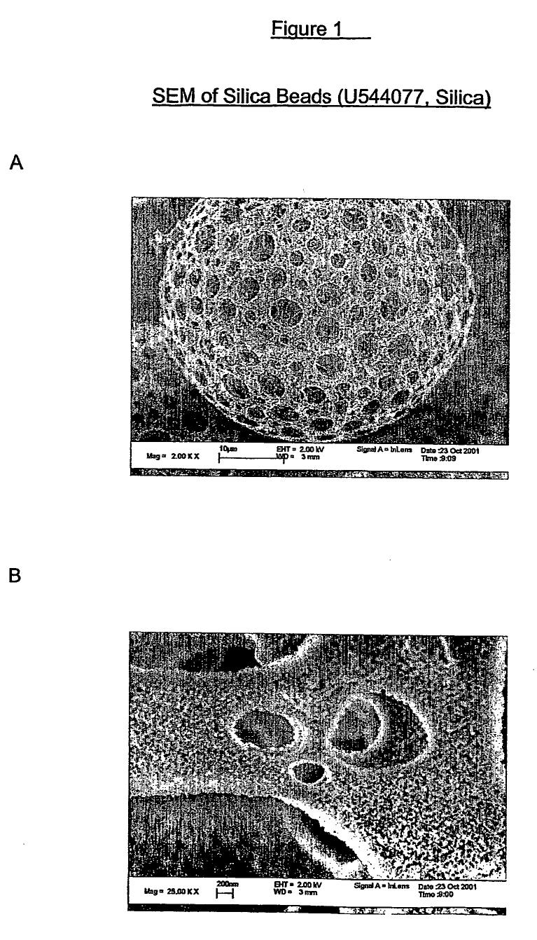

FIG. 1 shows Scanning Electron Microscope (SEM) pictures of silica beads of Example 1 in low (A) and high (B) magnifications. These beads show a hierarchical structure with a network of superpores (diameter up to 5 microns) and a set of small pores in the struts of the superpore structure.

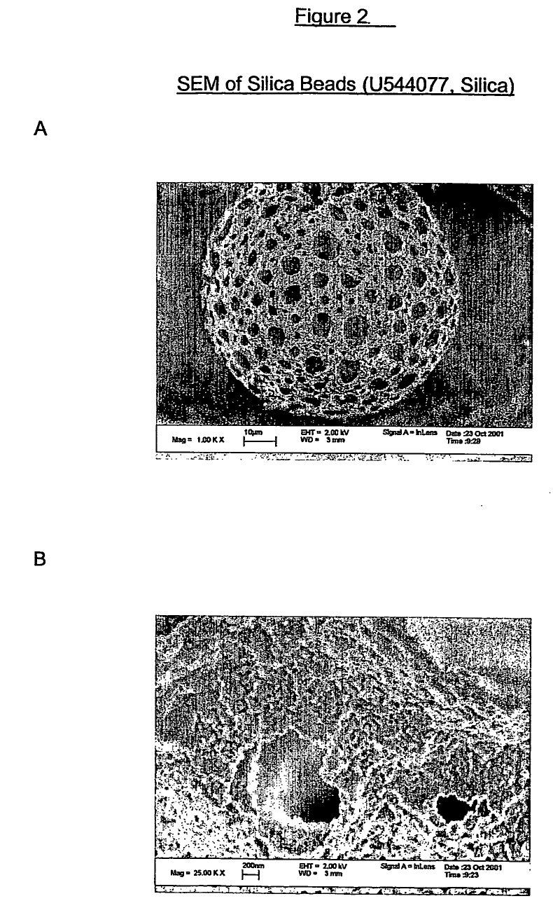

FIG. 2 shows SEM pictures of silica beads of Example 2 in low (A) and high (B) magnifications. These beads show a hierarchical structure with a network of superpores (diameter up to 10 microns) and a set of small pores in the struts of the superpore structure.

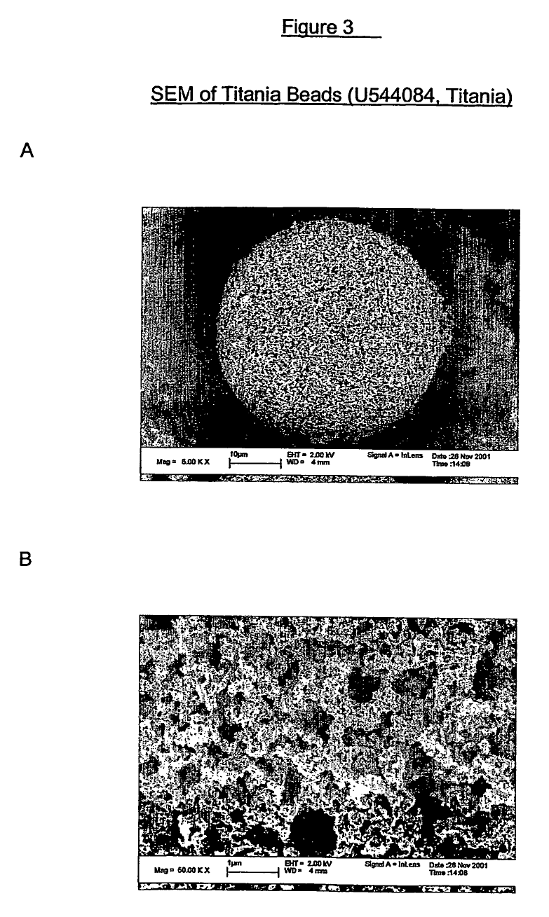

FIG. 3 shows SEM pictures of titania beads of Example 3 in low (A) and high (B) magnifications. These beads show a hierarchical structure with a network of micron-sized superpores connected to a set of small pores.

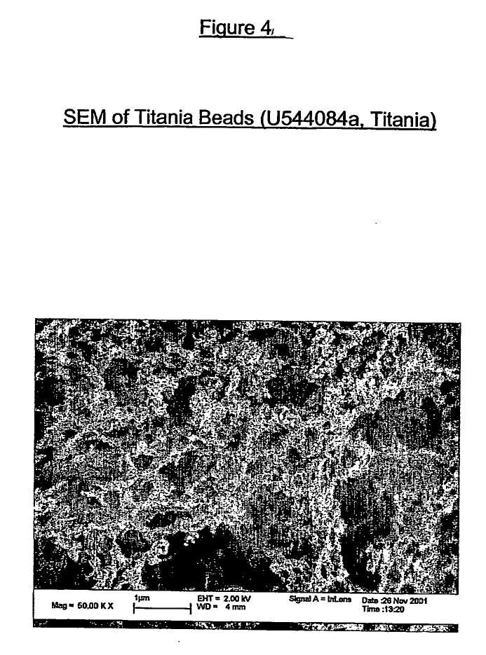

FIG. 4 is a SEM picture of the interior structure of a titania bead according to Example 4 in high magnification. These beads show a hierarchical structure with a network of micron-sized superpores connected to a set of small pores.

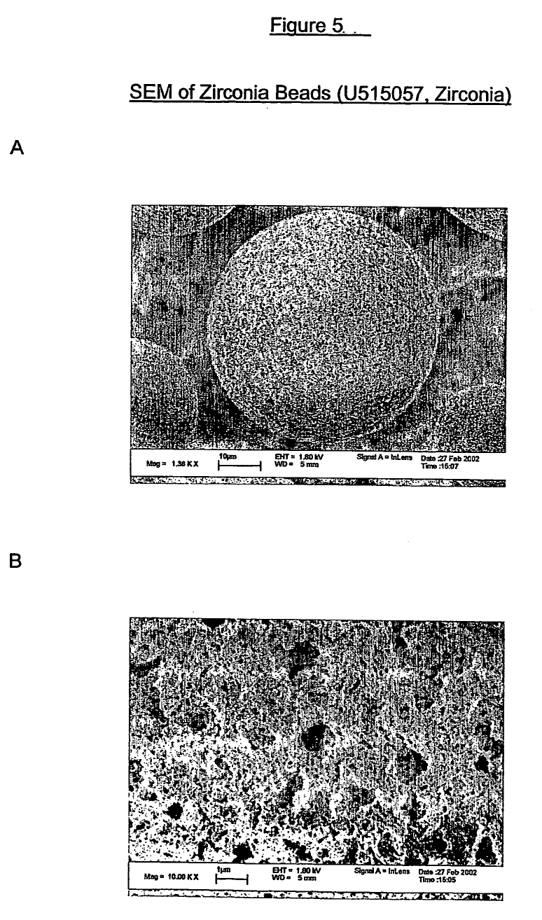

FIG. 5 shows SEM pictures of zirconia beads of Example 5 in low (A) and high (B) magnification. These beads show a hierarchical structure with a network of micron-sized superpores connected to a set of small pores.

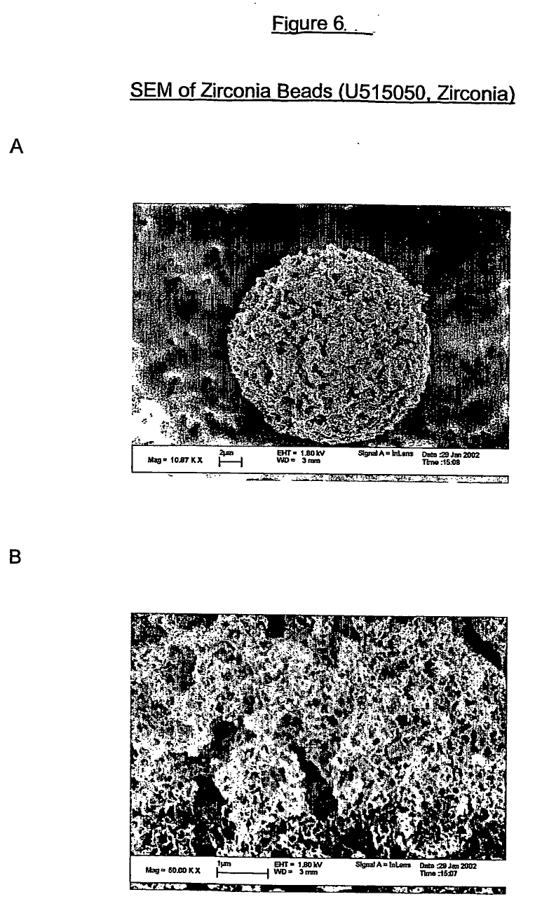

FIG. 6 shows SEM pictures of zirconia beads of Example 6 in low (A) and high (B) magnification. These beads show a hierarchical structure with a network of micron-sized superpores connected to a set of small pores.

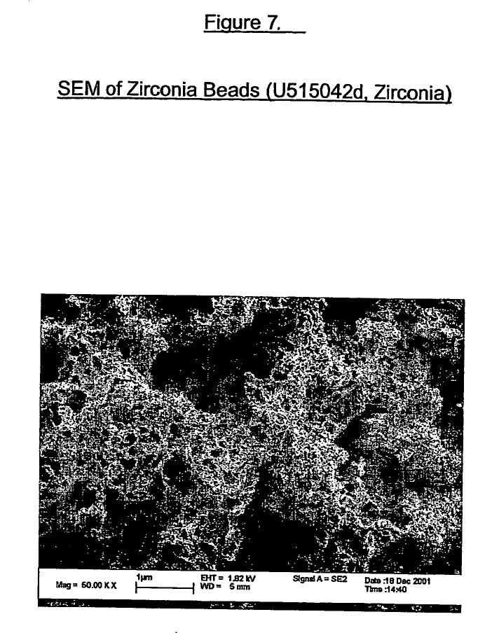

FIG. 7 is a SEM picture showing a zirconia bead of Example 7 in high magnification. These beads show a hierarchical structure with a network of micron-sized superpores connected to a set of small pores.

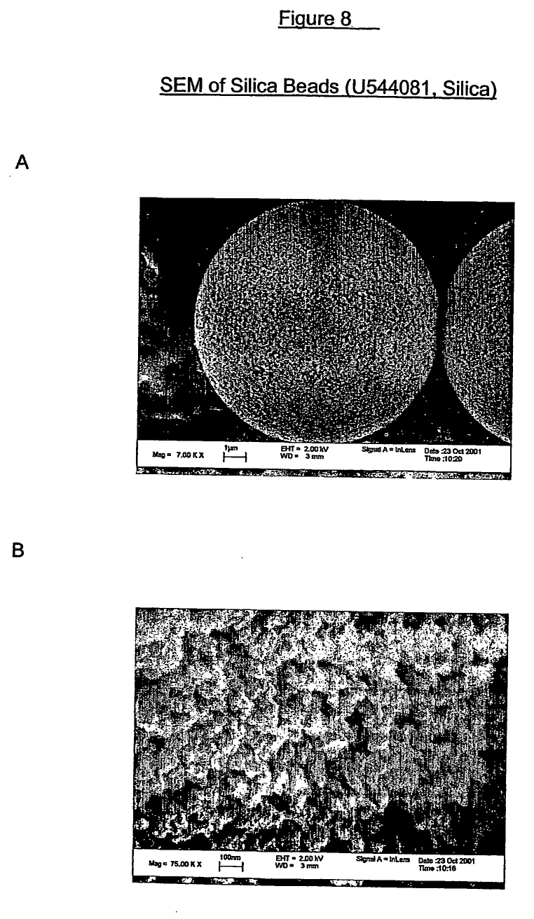

FIG. 8 shows SEM pictures of a comparative example of the preparation of non-hierarchical silica beads (U544081, Silica) according to Example 8 in low (A) and high (B) magnification. These beads show a typical sol-gel pore structure without signs of hierarchy.

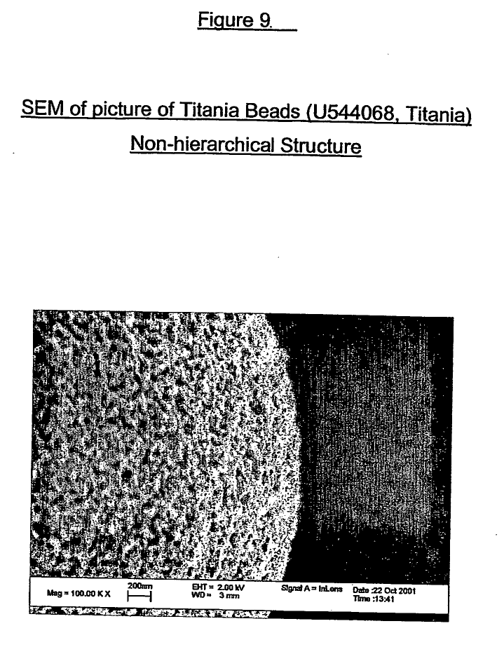

FIG. 9 is a SEM picture of a comparative example of the preparation of titania beads (U544068, Titania) according to Example 9 showing a typical sol-gel pore structure without signs of hierarchy.

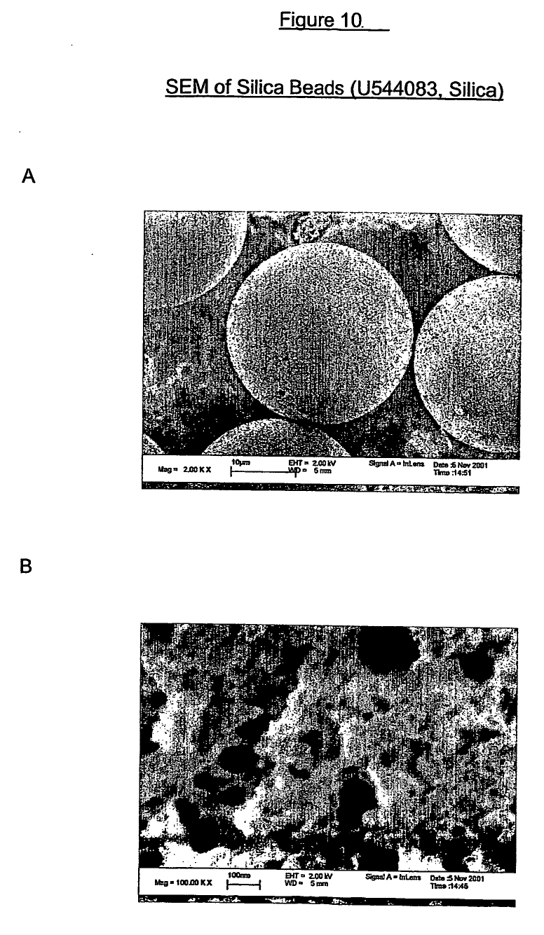

FIG. 10 shows SEM pictures of silica beads of Example 10 in low (A) and high (B) magnifications. These beads show a pore structure having a hierarchical pore structure with 100-200 nm superpores connected to a set of smaller pores.

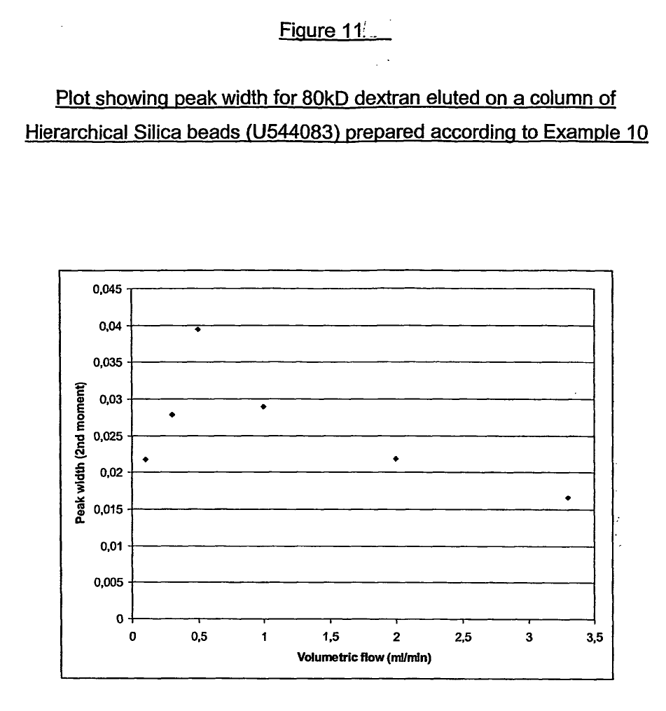

FIG. 11 is a plot showing peak width for 80 kD dextran eluted on a column of hierarchical silica beads (U544083) prepared according to Example 10. The absence of any width increase above 0.5 ml/min is a sign of improved mass transport from the hierarchical structure.

### EXAMPLES

### Example 1

### Preparation of Silica Beads (U544077, Silica)

Foamballs (average particle size 150 microns, pore size 5-10 microns) were prepared from styrene and divinylbenzene according to U.S. Pat. No. 5,902,834, Example 1.

Dried foamballs (2 g) were swollen in dichloroethane for 1 hour. Concentrated sulphuric acid (60 ml) was added and the reaction was allowed to proceed at 70° C. overnight. The sulphuric acid was removed from the beads by suction on a glass filter and the beads washed on a glass filter with plenty of water.

The sulphonated template beads were dried in an oven at 60° C. overnight. Dried beads (0.1 g) were soaked in 0.01M hydrochloric acid (10 ml) in a reactor equipped with an anchor stirrer. Tetramethylorthosilicate (135 μl) was added and the reaction was allowed to proceed at 70° C. for three days. The beads were washed on a glass filter with plenty of deionized water and subsequently dried at 60° C. overnight. The dried beads were calcined according to the following program;

| | | | | |
|---|---|---|---|---|
| i) | 0-90 | min: | 25-550° | C. |
| ii) | 90-1140 | min: | 550° | C. |

After 3.5-4 hours a constant airflow was allowed through the furnace to guarantee complete combustion of organic material.

### Example 2

### Preparation of Silica Beads (U544078, Silica)

Foamballs (average particle size 150 microns, pore size 5-10 microns) were prepared from styrene and divinylbenzene as in Example 1 above.

Dried foamballs (2 g) were swollen in dichloroethane for 1 hour. Concentrated sulphuric acid (60 ml) was added and the reaction was allowed to proceed at 70° C. overnight. The sulphuric acid was removed from the beads by suction on a glass filter. The beads were washed on glass filter with plenty of water.

Poly(diallyl dimethyl ammonium chloride) (polyDADMAC; 2.5 ml) was diluted to 10 ml with distilled water. Sulphonated organic beads were dried by suction on a glass filter. Thereafter, the organic beads 1.5 g) were swollen in the polymer solution in a reactor equipped with an anchor stirrer at room temperature for 6.5 hours. The beads were washed on a glass filter with plenty of distilled water.

The polyDADMAC-coated template beads were dried in an oven at 70° C. overnight. Dried beads (0.5 g) were soaked in 0.01M hydrochloric acid (10 ml) in a reactor equipped with an anchor stirrer. Tetramethylorthosilicate (6.8 ml) was added and the reaction was allowed to proceed at 70° C. for three days. The beads were washed on a glass filter with plenty of deionized water and dried at 60° C. overnight. The dried beads were calcined according to the following program;

| | | | | |
|---|---|---|---|---|
| i) | 0-90 | min: | 25-550° | C. |
| ii) | 90-1140 | min: | 550° | C. |

After 3.5-4 hours a constant airflow was allowed through the furnace to guarantee complete combustion of organic material.

### Example 3

### Preparation of Titania Beads (U544084c, Titania)

78 micron monodisperse polydivinylbenzene beads (total pore volume 2.1 ml/g, <10 nm pore diameter 0.027 ml/g, 10-40 nm 0.052 ml/g, 40-100 nm 0.135 ml/g, 100-200 nm 0.285 ml/g, 200-400 nm 1.050 ml/g, 400-1000 nm 0.534 ml/g) were obtained from Dyno Particles A/S, Lillestroem Norway (sample designation Dynospheres EXP-PD-70-RXE F-BAS/26-F).

Dried beads (4.0 g) were weighed into a flask and were thereafter additionally dried at 60° C. overnight. Titanium(IV)isopropoxide (2 g) was added and infiltration into the beads was allowed to proceed overnight. Water (100 ml) was then added and the reaction was allowed to proceed at room temperature for 4-7 hours on an agitation table. The inorganic/organic hybrid beads were washed on a glass filter with 3 portions of deionized water. The hybrid beads were then dried in an oven at 60° C. overnight. The calcination of titania beads followed the program of the silica beads described above.

### Example 4

### Preparation of Titania Beads (U544084a, Titania)

55 micron monodisperse polydivinylbenzene beads (total pore volume 2.0 ml/g, <10 nm pore diameter 0.017 ml/g, 10-40 nm 0.023 ml/g, 40-100 nm 0.139 ml/g, 100-200 nm 0.346 ml/g, 200-400 nm 0.932 ml/g, 400-1000 nm 0.536 ml/g) were obtained from Dyno Particles A/S, Lillestroem Norway (sample designation Dynospheres EXP-PD-70-RXE F-BAS/18-F).

Dried beads (4.0 g) were weighed into a flask and were thereafter additionally dried at 60° C. overnight. Titanium(IV)isopropoxide (2 g) was added and infiltration into the beads was allowed to proceed overnight. Water (100 ml) was then added and the reaction was allowed to proceed at room temperature for 4-7 hours on an agitation table. The inorganic/organic hybrid beads were washed on a glass filter with 3 portions of deionized water. The hybrid beads were dried in an oven at 60° C. overnight. Calcination of titania beads followed the program of the silica beads described above.

### Example 5

### Preparation of Zirconia Beads (U515057, Zirconia)

78 micron monodisperse polydivinylbenzene beads (total pore volume 2.1 ml/g, <10 nm pore diameter 0.027 ml/g, 10-40 nm 0.052 ml/g, 40-100 nm 0.135 ml/g, 100-200 nm 0.285 ml/g, 200-400 nm 1.050 ml/g, 400-1000 nm 0.534 ml/g) were obtained from Dyno Particles A/S, Lillestroem Norway (sample designation Dynospheres EXP-PD-70-RXE F-BAS/26-F).

Dried beads (4.0 g) were weighed into a flask and were thereafter additionally dried at 60° C. overnight. Zirconium(IV)propoxide (2 ml) was added and the infiltration into the beads was allowed to proceed overnight. Water (100 ml) was then added and the reaction was allowed to proceed at room temperature for 4-7 hours on an agitation table. The inorganic/organic hybrid beads were washed on a glass filter with 3 portions of deionized water. The hybrid beads were dried in an oven at 60° C. overnight. The calcination of zirconia beads followed the program below.

| | | | | |
|---|---|---|---|---|
| i) | 0-120 | min: | 25-750° | C. |
| ii) | 120-720 | min: | 750° | C. |

After 3.5-4 hours a constant airflow was allowed through the oven to guarantee complete combustion of organic material. The zirconia beads had a surface area (BET N₂ adsorption) of 21.6 m²/g.

### Example 6

### Preparation of Zirconia Beads (U515050, Zirconia)

Ethylene glycol dimethacrylate (42.3 g), 2-ethyl hexanol (119.0 g), styrene (8.9 g) and azobisdimethylvaleronitrile (1.0 g) were mixed in a beaker. This solution was poured into a 1 l glass reactor fitted with an anchor stirrer, containing 1% aqueous polyvinyl alcohol solution (Mowiol 40-88, Clariant) (680 ml) and potassium dichromate (3.6 g). The phases were emulsified at 450 rpm and the temperature was raised to 650C. After 2 hour, 1 M NaOH (50 ml) was added and the polymerisation was allowed to proceed overnight at 450 rpm. The resulting beads were washed with hot water, 20% ethanol, 50% ethanol and 100% ethanol. They were then sieved between 40 and 100 μm and dried at 60° C. The beads had a coarse pore structure with pores up to 1 μm diameter, as judged from SEM pictures.

Dried beads (5.3 g) were weighed into a flask and were thereafter additionally dried at 50° C. overnight. Zirconium(IV)propoxide (2.6 ml) was added and infiltration into the beads was allowed to proceed overnight. Water (100 ml) was then added and the reaction was allowed to proceed at room temperature for 4-7 hours on an agitation table. The inorganic/organic hybrid beads were washed on a glass filter with 3 portions of deionized water. The hybrid beads were dried in an oven at 60° C. overnight. The calcination of zirconia beads followed the program below.

| | | | | |
|---|---|---|---|---|
| i) | 0-120 | min: | 25-750° | C. |
| ii) | 120-720 | min: | 750° | C. |

After 3.5-4 hours, a constant airflow was allowed through the oven to guarantee complete combustion of organic material. The zirconia beads had a surface area (BET N₂ adsorption) of 19.9 m²/g.

### Example 7

### Preparation of Zirconia Beads (U515042d, Zirconia)

Ethylene glycol dimethacrylate (42.3 g), 2-ethyl hexanol (119.0 g), styrene (8.9 g) and azobisdimethylvaleronitrile (1.0 g) were mixed in a beaker. This solution was poured into a 1 l glass reactor fitted with an anchor stirrer, containing 1% aqueous polyvinyl alcohol solution (Mowiol 40-88, Clariant) (680 ml) and potassium dichromate (3.6 g). The phases were emulsified at 450 rpm and the temperature was raised to 65° C. After 2 h, 1 M NaOH (50 ml) was added and the polymerisation was allowed to proceed overnight at 450 rpm. The resulting beads were washed with hot water, 20% ethanol, 50% ethanol and 100% ethanol. They were then sieved between 40 and 100 μm and dried at 60° C. The beads had a coarse pore structure with pores up to 1 μm diameter, as judged from SEM pictures.

Dried beads, 30 mg, were weighed into a flask and were thereafter additionally dried at 60° C. overnight. Zirconium(IV)propoxide (0.1 ml) was added and infiltration into the beads was allowed to proceed overnight. Water (100 ml) was then added and the reaction was allowed to proceed at room temperature for 4-7 hours on an agitation table. The inorganic/organic hybrid beads were washed on a glass filter with 3 portions of deionized water. The hybrid beads were dried in an oven at 60° C. overnight. The calcination of zirconia beads followed the program below.

| | | | | |
|---|---|---|---|---|
| i) | 0-120 | min: | 25-750° | C. |
| ii) | 120-720 | min: | 750° | C. |

After 3.5-4 hours a constant airflow was allowed through the oven to guarantee complete combustion of organic material.

### Example 8

### Comparative Example: Preparation of Non-Hierarchical Silica Beads (U544081, Silica)

15 μm monodisperse SOURCE 15ETH beads (Amersham Biosciences, total pore volume 1.1 ml/g, <10 nm pore diameter 0.00 ml/g, 10-40 nm 0.25 ml/g, 40-60 nm 0.38 ml/g, 60-100 nm 0.20 ml/g, 100-400 nm 0.24 ml/g, 400-1000 nm 0.05 ml/g) were dried in an oven at 60° C. overnight Dried beads (5.0 g) were soaked in 0.01M hydrochloric acid (500 ml) in a reactor equipped with an anchor stirrer. Tetramethylorthosilicate (6.8 ml) was added (without any surfactant addition) and the reaction was allowed to proceed at 70° C. for three days. The beads were washed on a glass filter with plenty of deionized water and subsequently dried at 60° C. overnight. The dried beads were calcined according to the following program;

| | | | | |
|---|---|---|---|---|
| i) | 0-90 | min: | 25-550° | C. |
| ii) | 90-690 | min: | 550° | C. |

After 3.5-4 hours a constant airflow was allowed through the furnace to guarantee complete combustion of organic material.

FIG. 8 shows SEM pictures of silica beads of the comparative example in low (A) and high (B) magnifications. These beads show a typical sol-gel pore structure without signs of hierarchy.

### Example 9

### Comparative Example: Preparation of Titania Beads (U544068, Titania)

15 micron monodisperse polydivinylbenzene beads (total pore volume 2.1 ml/g, <10 nm pore diameter 0.427 ml/g, 10-40 nm 0.297 ml/g, 40-100 nm 0.378 ml/g, 100-200 nm 0.337 ml/g, 200-400 nm 0.333 ml/g, 400-1000 nm 0.368 ml/g) were obtained from Dyno Particles A/S, Lillestroem Norway (sample designation Dynospheres PD15RXE BAS-150).

Dried beads (4.0 g) were weighed into a flask and were thereafter additionally dried at 60° C. overnight. Titanium(IV)isopropoxide (4 g) was added (without any surfactant addition) and infiltration into the beads was allowed to proceed overnight. Water (100 ml) was then added and the reaction was allowed to proceed at room temperature for 4-7 hours on an agitation table. The inorganic/organic hybrid beads were washed on a glass filter with 3 portions of deionized water. The hybrid beads were then dried in an oven at 60° C. overnight. The calcination of titania beads followed the program of the silica beads described above.

FIG. 9 is a SEM picture of the titania beads of Example 9 showing a typical sol-gel pore structure without signs of hierarchy.

### Example 10

### Preparation of Silica Beads (U544083, Silica)

15 μm monodisperse SOURCE 30Q beads (Amersham Biosciences, total pore volume 1.1 ml/g, <10 nm pore diameter 0.00 ml/g, 10-40 nm 0.25 ml/g, 40-60 nm 0.38 ml/g, 60-100 nm 0.20 ml/g, 100-400 nm 0.24 ml/g, 400-1000 nm 0.05 ml/g) were dried in an oven at 60° C. overnight. Dried beads (5.0 g) were soaked in 500 ml 0.01M hydrochloric acid+10 g cetyl trimethylammonium bromide (surfactant) in a reactor equipped with an anchor stirrer. Tetramethylorthosilicate (6.8 ml) was added and the reaction was allowed to proceed at 70° C. for three days. The beads were washed on a glass filter with plenty of deionized water and subsequently dried at 60° C. overnight. The dried beads were calcined according to the following program;

| | | | | |
|---|---|---|---|---|
| i) | 0-90 | min: | 25-550° | C. |
| ii) | 90-690 | min: | 550° | C. |

After 3.5-4 hours a constant airflow was allowed through the furnace to guarantee complete combustion of organic material. The calcined beads had a surface area of 490 m²/g, with a nitrogen adsorption isotherm indicating a bimodal pore size distribution.

FIG. 10 shows SEM pictures of silica beads of Example 10 in low (A) and high (B) magnifications. These beads show a hierarchical structure with 100-200 nm superpores connected to a set of smaller pores.

The beads were then packed into a 5 mm diameter HR 5/5 column (Amersham Biosciences) to a bed height of 4.7 cm and an 80 kD dextran sample was injected and eluted isocratically with water. The peak width (calculated as the second moment of the peak) is plotted versus the volumetric flow rate in FIG. 11. For a normal pore structure, the peak width will increase monotonically with the flow rate. If the beads have a hierarchical pore structure with superpores penetrating the entire bead, it is expected that the peak width will be constant above a certain flow rate. As FIG. 11 shows, the peak width only increases up to 0.5 ml/min flow rate and then it decreases. This is a sign of an improved mass transport rate, attributed to the hierarchical pore structure.

FIG. 11. Peak width for 80 kD dextran eluted on a column of hierarchical silica beads (U544083) prepared according to Example 10. The absence of any width increase above 0.5 ml/min is a sign of improved mass transport from the hierarchical structure.

### Example 11

### Conversion of Silica Beads into Cation Exchange Beads: Determination of the Dynamic Protein Capacity of the Beads

Organic template beads (SOURCE 15ETH) (20 g) were dried in an oven at 65° C. for approx 36 h. Cetyltrimethylammonium bromide (CTAB) (40.4 g) was dissolved in 2000 ml 0.01M HCl solution. To dissolve the surfactant the solution had to be heated to 45° C. and then cooled to room temperature. The dried beads were soaked in the CTAB/HCl solution in a reactor equipped with small Teflon blade stirrer for approx. 1.5 h. Tetramethylorthosilicate (27.2 ml) was added and the reaction was allowed to proceed at 70° C. during 72 hours. The beads were washed on a glass filter with approx. 10 liters of deionized water and the washed beads dried overnight at 60° C.

The dried beads were calcined in an oven according to the following program:

| | | | | |
|---|---|---|---|---|
| i) | 0-90 | min: | 25-550° | C. |
| ii) | 90-690 | min: | 550° | C. |

After 3.5-4 hours a small constant airflow was allowed through the oven to guarantee complete combustion of organic material. The result was white spherical particles having a diameter of approximately 12 micron; total weight of 4.7 g.

Toluene (60 ml) was added to a 100 ml reactor equipped with small Teflon blade stirrer. 4.57 g dried silica beads and 600 microliters deionized water were added under stirring. The solution was stirred for approx. 15 minutes at room temperature and then glycidoxypropyltrimethoxysilane (10.5 ml) was added to the reactor. The solution was heated to 70° C. and the reaction was allowed to proceed at 70° C. during 22 hours. The beads were washed on a glass filter with toluene, ethanol and deionized water. Remaining water was removed by dry suction of the beads.

The epoxy activated beads were transferred to a 100 ml vial. Sodium sulphite (15 g) was dissolved in deionized water (75 ml) and added to the vial. The solution was slightly basic, about pH 8. The vial was closed but an injection needle was inserted through the gasket to prevent high pressure build-up inside the vial. The vial was placed in an oven and the reaction was allowed to proceed at 100° C. during 47 hours. The particles were washed with deionized water. Fines were removed by elutriating the solution twice in a 50 ml graduated measuring cylinder. The beads were sieved with a 40 micron sieve. The volume of the sieved S-Silica was estimated to about 19 ml.

The beads were packed in a HR5/5 column (Amersham Biosciences) and tested with respect to dynamic capacity of the protein chymotrypsinogen. At 300 cm/h flow velocity, the capacity (10% breakthrough level) was 155 mg protein/ml gel. At 900 cm/h, the capacity was 160 mg/ml. For a comparable commercial 10 micron cation exchanger, Mono S (Amersham Biosciences), the capacity was 75 mg/ml at 300 cm/h and 74 mg/ml at 900 cm/h.

1. A method of producing at least one porous bead, comprising the steps of:
i) combining in a liquid medium at least one porous templating particle and a matrix material precursor under conditions such that said matrix material precursor infiltrates said templating particle(s);
ii) allowing said matrix material precursor to solidify to form composite beads; and
iii) removing said templating particle(s) from said composite bead(s) thereby resulting in porous beads comprising a porous matrix supplemented with one or more larger pores corresponding to the cavities left by the removed templating particle(s);
wherein said at least one porous templating particle is a bead having a macroporous structure and said combining step i) is performed in the presence of a surfactant;
whereby a hierarchical network of pores is provided in each bead.

2. The method of claim 1, wherein a surfactant is present in the liquid medium when the templating particle(s) are added therein.

3. The method of claim 1, wherein said templating particle(s) are treated with a surfactant before they are added to the liquid medium.

4. The method of claim 1, further comprising the step of treating the templating particles with a surface modifying agent.

5. The method of claim 4, wherein said treatment step precedes step i).

6. The method of claim 1, wherein said templating particle(s) are beads having a macroporous structure with at least 50% of the pore volume in pores with diameters in the range from 40 nm to 20,000 nm.

7. The method of claim 1, wherein said templating particle(s) are selected from porous organic polymer beads having at least 50% of their total intraparticle pore volume in pores in the range from 100 nm to 10,000 nm pore diameter.

8. The method of claim 1, wherein said matrix material precursor is a metal salt or a metal or metalloid complex.

9. The method of claim 1, wherein said matrix material precursor upon calcination forms an oxide selected from the group consisting of TiO₂, SiO₂ and ZrO₂.

10. The method of claim 1, wherein said hierarchical network of pores comprises a bimodal hierarchical pore structure having mesopores connected to macroporous cavities or channels that are formed when the templating particle is removed.

11. The method of claim 10, wherein said cavities or channels have a diameter range of between about 50 nm and about 20,000 nm.

12. The method of claim 10, wherein said cavities or channels have a diameter range of between about 50 nm and about 10,000 nm.

13. The method of claim 10, wherein said mesopores have a diameter range of between about 1 nm and about 100 nm.

14. A separation matrix comprising porous beads of claim 1, wherein a hierarchical network of pores is provided in each bead.

15. The separation matrix of claim 14, wherein said beads are spherical or substantially spherical in shape, having a diameter in the range from about 1 μm to about 500 μm.

16. The separation matrix of claim 14, wherein said beads are spherical or substantially spherical in shape having a diameter in the range of 10 μm to about 100 μm.

17. A liquid chromatography procedure for separating and distinguishing at least one solute in a chromatography column containing a stationary separation matrix, including the steps of flowing through said column a discrete volume of a liquid mixture containing said solute(s) and eluting from said separation matrix said solute(s) bound thereto;
wherein said separation matrix is comprised of porous beads exhibiting an essentially hierarchical pore structure that favours mass transport wherein said beads are obtainable by the method of claim 1.
